(19) United States
(12) Patent Application Publication
(10) Pub. No.: US 2003/0046165 A1
(43) Pub. Date: Mar. 6, 2003

(54) Process for modification of Ad content by localization

(76) Inventor: Drew Topel, Burlingame, CA (US)

Correspondence Address: OPPENHEIMER WOLFF & DONNELLY, P. O. BOX 10356, PALO ALTO, CA, 94303, US

(21) Appl. No.: 10/230,843

(22) Filed: Aug. 28, 2002

Related U.S. Application Data
(60) Provisional application No. 60/316,891, filed on Aug. 31, 2001.

(51) Int. Cl. G06F 17/60

(52) U.S. Cl. 705/14

(57) ABSTRACT

A process for modification of ad content to be displayed in a particular geographic location is “localized” to include content modified to fit the particular locale. A remote Ad Player is linked through a wired or wireless connection or network (LAN, MAN or WAN) to a central Ad Server that knows the location of each such device. A plurality of ads created as a combination of digital files are stored in a database associated with the Ad Server. Each ad includes a control file and a list of components, and for each component, a localization table identifies location specific modifications of at least some of the components. Since the Ad Server knows the location of each Ad player, it can localize an ad before it is sent to a particular Ad Player, or alternatively, the Ad Server can send the ad file package and the appropriate component files to the remote Ad Player and allow the Ad Player to perform the localization function as it assembles the ad.

### RELATED APPLICATION

This application claims the benefit of U.S. Provisional Application No. 60/316,891, filed Aug. 31, 2001, and entitled Automatic Modification of Ad Content by Localization, the entire contents of such application being expressly incorporated herein by reference.

### FIELD OF THE INVENTION

The present invention relates generally to network based advertising and control of remote displays, and more particularly to a method and process by which audio/visual ad content can be modified either remotely or on-site by localization information.

### BACKGROUND OF THE INVENTION

The present invention utilizes what is now a common system for delivering advertising (ad content), including audio, still frame and/or full motion advertisements, to one or more electronic display devices. As generally depicted in FIG. 1 of the drawing, such systems typically include a central Server and a plurality of display devices linked together by a network that may comprise, for example, a cable network, a wide area network (WAN), municipal area network (MAN), a local area network (LAN), the Internet; an Intranet, or any combination of the above. Data is transmitted from the Server over the network via a carrier such as cable, fiber optic lines, telephone lines, wireless connections, and so on, to the display devices which may be located as close as next door, or as remote as thousands of miles away. Actual networks can be arranged in a variety of configurations; however, the example shown here provides a framework for understanding the type of environment in which the present invention operates.

The network environment relevant to the present invention usually includes a plurality of Ad Players that are connected to an Ad Server by way of a communications network. The Ad Players and Ad Server are connected to the communications network by way of appropriate communication interfaces well know in the art which may also include a LAN, MAN or WAN. Such networking environments are commonplace in enterprise-wide computer networks, Intranets and the Internet.

The Ad Server provides management of software services that are accessible to the Ad Player via the communications network. The software services provided may be, for example, accessible by way of Internet Protocol by addressing the Ad Server via a Universal Resources Locator (URL). For example, if the Ad Server were to be located at www.coolsign.com, then the Ad Players would be accessible using a conventional browser, such as Microsoft Explorer, at the URL: http://www.coolsign.com. Moreover, although the Ad Server is depicted in FIG. 1 as a single unit, it should be appreciated that such a depiction is for illustrative purposes only. An actual implementation may consist of many servers either co-located or geographically dispersed such as by distributing the functions, using mirror sites, and so on.

As part of its function as a server, the Ad Server may provide access to or maintain information. Typically, server computers maintain information in databases, such as that illustrated, by way of database server system software. The Ad Server might, for example, run Microsoft Windows NT 4.0 operating system and Microsoft SQL Server 7.0 database management software.

In the example shown in FIG. 1, the Ad Server might provide services relating to displaying programming content on display devices, such as those shown. As such, an Ad Player which is associated with a particular display device, desiring to display programming on its associated display device, might access the Ad Server over the communications network to obtain computing services, upload programming content, and so on. The Ad Server would then accept the programming content to be displayed, or provide services to generate programming content, and communicate the programming content to the Ad Player, which would in turn render the programming content on its display device. The programming content can be sent as MPEG packets, HTML pages, XML, AVI video, FLASH video, and other protocols for distributing content over a communications network.

Although such prior art systems are quite useful in that they allow an advertiser to select those ads that, based on the known demographics of a region, will be most appropriate for an audience in a particular location, such systems do not allow modification of ads so that the same ad can be specifically tailored to fit particular characteristics of the venue in which it is to be displayed. There is thus a need for a system and method by which ad content can be modified as appropriate to better suit a particular local environment or venue.

### SUMMARY OF THE INVENTION

It is therefore a principal objective of the present invention to provide a method or process of enabling advertisements to be localized so that they are more consistent with the local characteristics of the area and or audience.

Another objective of the present invention to provide a method or process whereby various attributes of an advertisement can be changed to more nearly comport with the ethnicity of the local audience.

Still another objective of the present invention to provide a method or process that permits the various constituent parts of an advertisement to be selected and assembled in a way that will be more attractive to a local audience.

Briefly, a presently preferred embodiment of the present invention includes a process whereby an advertisement selected for display in a particular geographic location can be “localized” to include content that has been modified to fit the particular locale. The advertisement in such case is usually one that has been made to be displayed on a device that shows dynamic content. Typically, this means that the ad is an electronically encoded graphic, and perhaps includes an audio file, and has been designed to be shown on a device such as a computer monitor or plasma display device driven by an Ad Player. The Ad Player, if remotely located, must also be linked through a suitable wired or wireless connection or a communication network (LAN, MAN or WAN) to a central Ad Server that knows the location of each such device through its database of display locations. In accordance with the invention, a plurality of ads are created as a combination of digital files that are stored in a database associated with the Ad Server. Each ad includes a control file and a list of component parts, and for each component, a localization table is provided that identifies location specific modifications of at least some of the components. Thus, since the Ad Server knows the geographic location of each Ad player to which it is connected, it can localize an ad before it is sent to a particular Ad Player or alternatively, the Ad Server can simply send the ad file package and the appropriate component files to the remote Ad Player and allow the Ad Player to perform the localization function as it assembles the ad.

An important advantage of the present invention is that allows an advertisement to be simultaneously run in a plurality of culturally diverse venues, with each ad being appropriately configured for the location in which it is displayed and/or performed.

Another advantage is that the same ad can be run in the same location at a different time of day and be modified to suit the tastes, ethnicity or lifestyle of the viewing audience.

Still another advantage of the present invention is that it allows an ad to be continuously updated to follow changes in local audience or environmental makeup.

These and other objects and advantages of the present invention will no doubt become apparent to those skilled in the art after having read the following detailed disclosure of the best mode which makes reference to the several figures of the drawing.

### IN THE DRAWING

FIG. 1 is a block diagram schematically illustrating an overall system environment in which the invention is practiced;

FIG. 2 is a block diagram schematically illustrating the data content of the Ad Server used in accordance with the present invention;

FIG. 3 is a block diagram schematically illustrating the interactive relationship between the Ad Server and an Ad Player when operating in accordance with the present invention; and

FIG. 4 is a flow chart illustrating the program flow of the process of the present invention.

### DETAILED DESCRIPTION OF THE BEST MODE

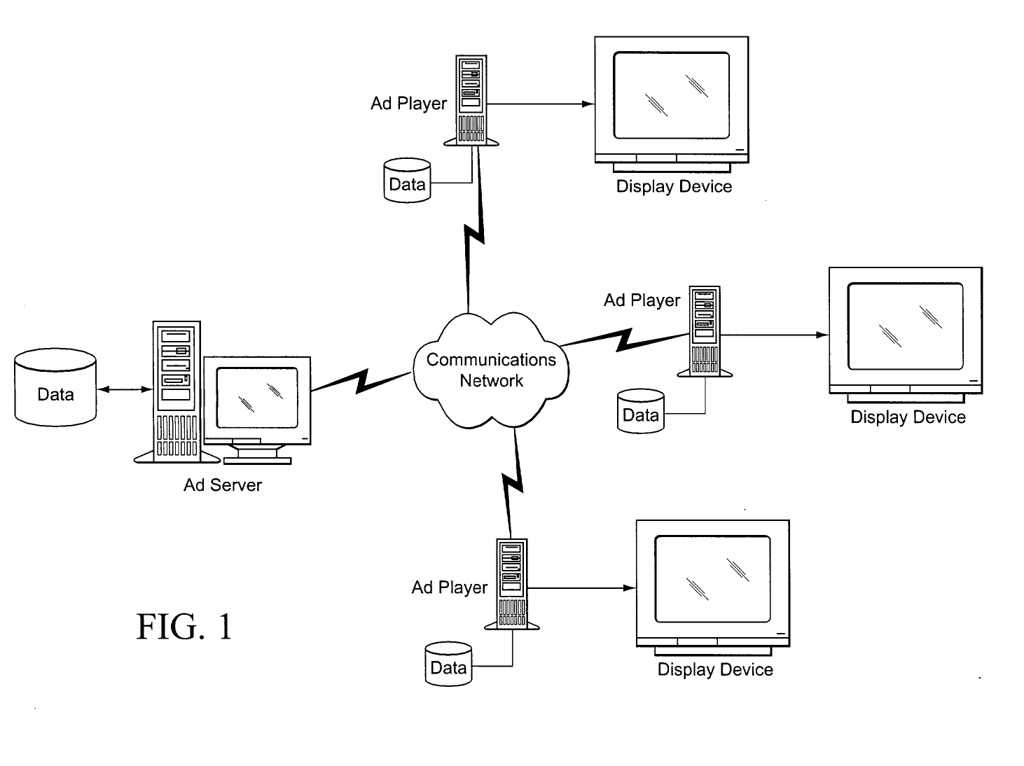

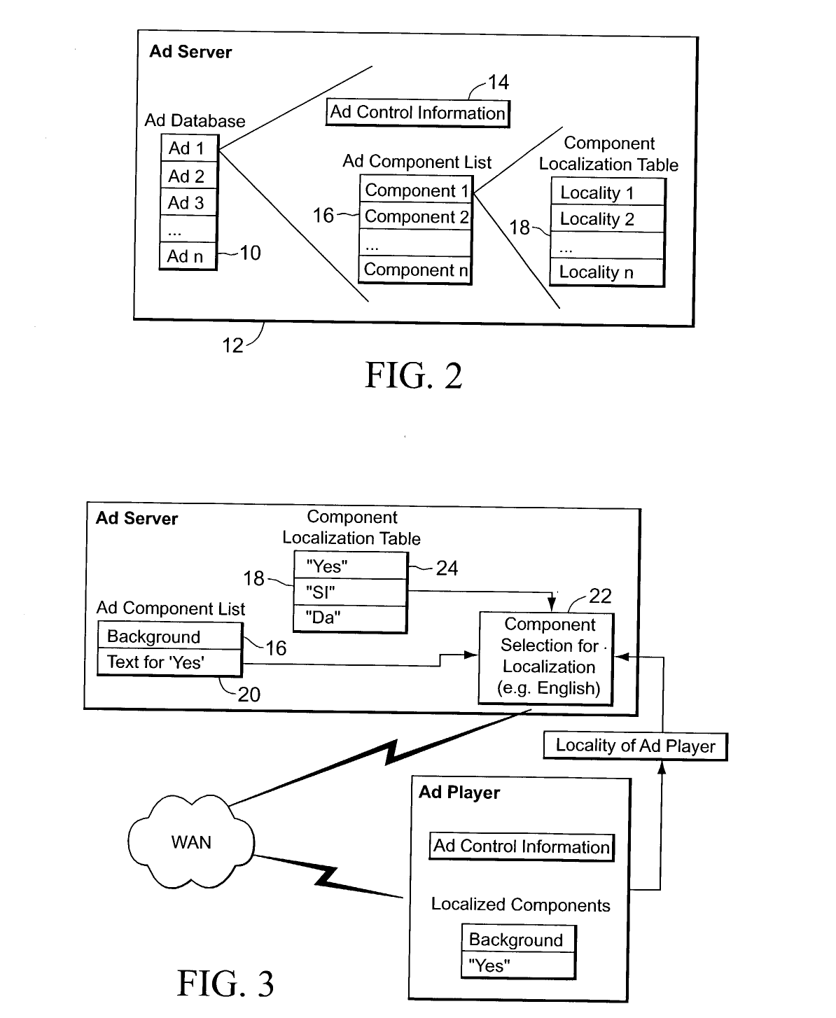

Referring now to FIG. 2 of the drawing, there is shown a series of tables that identify ad packages 1−n and their constituent parts stored in the Ad Database 10 of an Ad Server 12. These ad packages each include data relating to an ad that is to be shown or “played” on the various Display Devices making up a display network such as that depicted in FIG. 1. As depicted, each ad package in the Ad Server Database includes a control file 14 that contains the master instruction set for driving a remote Ad Player and indicates how an ad is to be assembled at runtime. Each ad package also includes an ad component list 16 that identifies each component of the corresponding ad.

For each component found in the ad component list, there is a component localization table 18 that contains ‘customizations’ corresponding to each locality in which the ad is to be played. The customizations include a wide variety of alternatives for each component. For example, if the component is a background color, many choices may be available; if the component includes people, people having different ethnic features may be selectable; similarly, different background settings may be selected; and, if the component is an audio component, statements in several languages or different types of background music or ambient sounds may be available for selection.

In FIG. 3, the process of localization is illustrated in simplified form as is automated in the Ad Server. Each element, or component, of the ad component list must be sent to the Ad Player along with the Ad Control Information. But each component has the potential to be localized via the component localization table that is associated with each such component. The localization can be accomplished at the Ad Server or, after transmission, at the receiving Ad Player. In this example, the “Text for ‘Yes’” component 20 is localizable. In accordance with the present invention, the Component Selection process for Localization 22 operator determines the locality of the particular Ad Player, finds that the audience is English speaking, looks to the Component Localization Table 18 for the English word for “yes”, and appropriately substitutes the element 24 for the component 20 to be localized.

In this example note that the localization criteria for an ad is English. So the English word ‘Yes’ is selected out of the possible localization component choices and sent along with the ad's other components and control information to the remote Ad Player. Thus, the table of ad components sent to the player contains components that have been localized for that Ad Player.

Given that any component can be customized for a particular locality, it is up to the producer of the ad to identify the components that need to be changeable to allow localization for the ad. He then creates each localization component and stores them in the Component Localization Table 18 so that the selection process can find the right localization component for delivery to a particular ad player.

As another example, if the ad is to be played in a Spanish-speaking neighborhood, the ad would be changed to show all of its text, and play all of its audio in Spanish. The ad can also be customized in other ways to appeal to the backgrounds of the people to which it is targeted. For example, if the ad is to be displayed in the city, it might feature people who are dressed in business attire, but if it is to be played in a more country or suburban setting, the models would wear more casual clothes, etc.

As an alternative, rather than transmitting localized ad packages to the remote Ad Players, it may be desirable in certain circumstances to transmit a complete ad package including the Component Locality Table for the ad in question to the remote Ad Player so that the localization function can be performed locally. This might be desirable, for instance, in a case where the desired attributes of a particular component might change over a period of time. As an example, if the venue is a resort airport and the incoming/outgoing flights at a particular dock at particular times of day carry passengers from geographically diverse regions of the world, it might be desirable that the advertisement be localized on a periodic basis to match the profiles of the viewers. Conceivably, it might be more advantageous to perform the localization function locally at the Ad player rather than at the Ad Server.

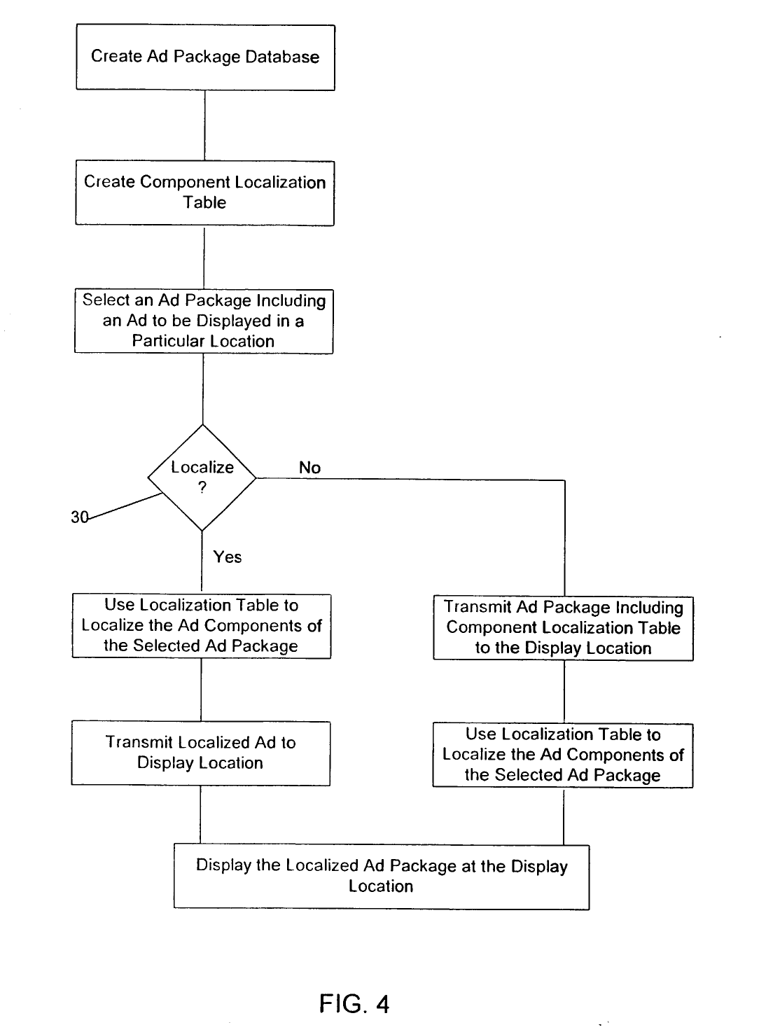

In conclusion, reference is made to the flow chart diagram of FIG. 4 wherein the principal operative steps of the present invention are set forth by way of example. As illustrated by the inclusion of the decision box 30, the invention can be practiced by performing the localization function at either the Ad Server or the remote Ad Player. In either case, the result is that the ad content of the advertisement is enhanced.

Although the present invention has been described in terms of a preferred embodiment, it is anticipated that other alterations and modifications will become apparent to those skilled in the art after having read the above disclosure. It is therefore intended that such disclosure be considered illustrative and not limiting, and that the appended claims be interpreted to include all such embodiments, alterations and modifications as fall within the true spirit and scope of the invention.

What is claimed is:

1. A method of localizing ad content for display at a particular location, comprising the steps of:
creating a database of location independent ad packages, each of which is comprised of an ad control file and an ad component table;
creating for each component in each said ad component table, a component localization table including localizing alternatives, having characteristics corresponding to particular locations;
selecting a particular ad package from the database including an ad to be displayed in a particular location;
localizing the selected ad package by substituting for the ad components in the corresponding component table, particular localizing alternatives taken from said localization table; and
transmitting the localized ad package to an ad player for use in displaying the associated ad on a display unit in the particular location.

2. A method of localizing ad content as recited in claim 1 and further comprising playing the localized ad at the particular location.

3. A method of localizing ad content for display at a particular location, comprising the steps of:
creating a database of location independent ad packages, each of which is comprised of an ad control file and an ad component table;
creating for each component in each said ad component table, a component localization table including localizing alternatives, having characteristics corresponding to particular locations or environments;
selecting a particular ad package from the database including an ad to be displayed in a particular location or environment;
transmitting the ad package including all variations on the localization data to an ad player;
localizing the selected ad package in the ad player by substituting for the ad components in the corresponding component table, particular localizing alternatives taken from said localization table; and
displaying the localized ad.

4. A method of localizing ad content for display at a particular location, comprising the steps of:
creating a database of location independent ad packages, each of which is comprised of an ad control file and an ad component table;
creating for each component in each said ad component table, a component localization table including localizing alternatives, having characteristics corresponding to particular locations;
selecting a particular ad package from the database including an ad to be displayed in a particular location;
determining whether or not the selected ad package is to be localized or transmitted;
if said selected ad package is to be localized then
localizing the selected ad package by substituting for the ad components in the corresponding component table, particular localizing alternatives taken from said localization table; and
transmitting the localized ad package to an ad player for use in displaying the associated ad on a display unit in the particular location;
if said selected ad package is to be transmitted to said particular location then
transmitting the selected ad package to an ad player at the particular location; and
localizing the transmitted ad package in said ad player by substituting for the ad components in the corresponding component table, particular localizing alternatives taken from said localization table.

5. A method of localizing ad content as recited in claim 4 and further
comprising playing the localized ad at the particular location.
